(19) United States
(12) Patent Application Publication
(10) Pub. No.: US 2007/0076297 A1
(43) Pub. Date: Apr. 5, 2007

(54) TRANSMISSION TYPE OPTICAL ELEMENT

(76) Inventor: Katsuhide SHIMMO, Tokyo (JP)

Correspondence Address: WHITHAM, CURTIS & CHRISTOFFERSON, P.C.;SUITE 340, 11491 SUNSET HILLS ROAD, RESTON, VA, 20190, US

(21) Appl. No.: 11/537,765

(22) Filed: Oct. 2, 2006

(30) Foreign Application Priority Data
Oct. 3, 2005 (JP) P2005-290066

(51) Int. Cl. G02B 5/18; G11B 7/135

(52) U.S. Cl. 359/569; 369/112.05

(57) ABSTRACT

The invention relates to a transmission type optical element configured so that a convex/concave structure is formed on a surface thereof, and that incident light to the optical element is subjected to an action at the convex/concave structure. In this optical element, a layer having a convex/concave structure is formed on one of surfaces of a substrate. The transmittance of each of the substrate and the layer having the convex/concave structure at a wavelength of 360 nm is set to be 90% or more so that the transmittance of the layer having the convex/concave structure is equal to or less than the transmittance of the substrate.

### BACKGROUND OF THE INVENTION

1. Field of the Invention

The present invention relates to a transmission type optical element used in various fields of optics and, more particularly, to a transmission type optical element used in an ultraviolet wavelength region.

2. Related Art

Ultraviolet light is shorter in wavelength than visible light. Thus, optical devices utilizing ultraviolet light features that an optical resolution is high. For example, according to lithography techniques, the shorter the wavelength used to form patterns, the finer the pattern that can be formed. Also, in the field of optical recording, the shorter the wave length used to write information, the higher the information recording density that can be enhanced.

However, materials capable of transmitting ultraviolet light are limited. The material, which is most commonly used to form an ultraviolet transmission type optical element, is quartz glass (for example, see JP-A-10-158035). The quartz glass is a good material that has a high transmittance in the ultraviolet wavelength region and that is moderately priced and is chemically stable. Optical functions are imparted by forming a fine convex/concave structure on a surface of quartz glass. Thus, a transmission type optical element utilizing ultraviolet light can be realized.

For instance, JP-A-2005-99707 discloses a technique of forming minute projections to reduce reflection on a surface of a transparent substrate. Additionally, diffractive optics and polarization optics are known as optical elements utilizing a fine convex/concave structure.

Meanwhile, it is necessary for the transmission type optical element to reduce reflection on a surface thereof so as to decrease insertion loss regardless of the wavelength of light used therein and as to enhance efficiency in utilizing light. Means therefor are a means of providing an antireflection layer on a surface of an optical element, and a means of providing a convex/concave structure in a surface of an optical element, as disclosed in JP-A-2005-99707. Among such means, a means more suitable for conditions of an optical element is selected.

To form the fine convex/concave structure directly on quartz glass, low-temperature processes, such as press-working, cannot be applied thereto. Thus, there is no choice but to perform a vapor phase etching method, such as an ion beam etching method described in JP-A-2005-99707. Such a vapor phase etching method requires a large-scale vacuum apparatus. The vapor phase etching method also requires patterning techniques, such as photolithography, to form an etching mask. Thus, complex and time-consuming processes are required to manufacture optical elements.

Also, processes of forming a film and processing are required to form antireflection means that are needed for enhancing efficiency in utilizing light in the transmission type element, in addition to the process of manufacturing the optical element itself.

### SUMMARY OF THE INVENTION

The invention is accomplished to solve such problems. An object of the invention is to provide a transmission type optical element having a convex/concave surface structure, which can be manufactured by performing a simple process.

According to the invention, there is provided a transmission type optical element comprising:

a substrate; and

a layer having a convex/concave structure formed on one of surfaces of said substrate;

wherein a transmittance of each of said substrate and said layer having said convex/concave structure at a wavelength of 360 nm is set to be 90% or more, and a refractive index of said layer having said convex/concave structure is less than a refractive index of said substrate.

With this configuration, it can be avoided to process the convex/concave structure directly on the substrate. A layer, on which the convex/concave structure can be processed, is formed on the substrate thereby to facilitate the manufacture of a transmission type optical element. Also, the productivity of the optical element can be enhanced. Additionally, the transmission type optical element can favorably transmit ultraviolet light and can obtain an antireflection effect by the surface layer. Thus, the invention can provide a transmission type optical element, which has high efficiency in utilizing light, by performing a simple manufacturing process.

Incidentally, the substrate according to the invention is not limited to the plate-like substrate. Even a substrate having a spherical surface like a lens or an aspherical surface can obtain similar effects. Also, in a case where the wave length dependence of the transmittance of each of the substrate and the layer is set so that the transmittance thereof at a wave length of 360 nm is 90% or more, a part of the obtained optical element is fixed by, for example, an ultraviolet curable resin. Thus, the obtained optical element is easy to utilize. Additionally, the high transmittance can suppress heat generation, structural deterioration, and change in color due to absorption of ultraviolet light.

Also, preferably, a second layer, which has a transmittance of 90% or more at a wavelength of 360 nm and which has a refractive index less than a refractive index of the substrate at the wavelength of 360 nm, may be provided on another surface of the substrate, which is opposed to the surface provided with the layer on which the convex/concave structure is formed.

The layers having low-refractive-indexes are provided on both surfaces of the substrate. Thus, the invention can provide a transmission type optical element enabled to further reduce reflection and to have high efficiency in utilizing light. The convex/concave structure may be formed in both of the layers respectively formed on the surfaces of the substrate. However, even in a case where one of the layers respectively formed on the surfaces of the substrate is formed as a flat layer, an advantage in enhancing the transmittance can be obtained. In a case where dip coating is performed when the layers are collectively formed on the both surfaces of the substrate, respectively, the layers can be formed on both the surfaces by performing a coating operation thereon only once.

Preferably, the layer having the convex/concave structure may be a layer on which the convex/concave structure is formed by molding and hardening a sol-like silicon alkoxide layer. Silicon alkoxide is gelated and is hardened by being heated. Thus, silicon alkoxide can be used as a molding material and is suitable for forming a layer having a convex/concave structure. Also, a layer having SiO₂ as a main ingredient is formed by hardening silicon alkoxide. The formed layer transmits ultraviolet light well.

Also, preferably, the material of the substrate may be quartz glass or sapphire glass. It is well known that quartz glass or sapphire glass transmits ultraviolet light well. Generally, a layer obtained by hardening silicon alkoxide is porous and has a refractive index, which is lower than that of such glass, in the ultraviolet wavelength region. Thus, the layer obtained by hardening silicon alkoxide can easily be utilized as an antireflection layer.

Preferably, average thicknesses d1 and d2 of said layers that are respectively formed on both of said surfaces of said substrate and that have refractive indexes n1 and n2 at a wavelength λ, at which said transmission type optical element is utilized, may be set so that each of values of optical thicknesses n1·d1 and n2·d2 of said layers is within a range defined by an odd multiple of (λ/4)±20%.

Consequently, the phase of light being incident from one direction is substantially cancelled by the phase of light reflected between the layer and the substrate and the layer and the exterior. The antireflection effect by a single layer can be enhanced. Incidentally, the average thickness means the average of the thickness at each convex part and that at each concave part of the convex/concave structure.

Also, preferably, a depth of said convex/concave structure may range from 0.1 μm to 0.9 μn. Incidentally, the depth is a distance from the top of the convex part to the bottom part of the concave part. In a case where the depth is less than 0.1 μm, the depth corresponding to the wavelength is too small. Thus, a sufficient diffraction effect cannot be obtained. Therefore, this case is unfavorable. Meanwhile, a transfer-moldable material containing SiO₂ as a main ingredient is contracted when hardened after the transfer molding is performed. Therefore, in a case where the depth is larger than 0.9 μm, the structure of the layer cannot be maintained. Cracks are easily formed therein. Accordingly, this case is unfavorable.

According to the invention, when the convex/concave surface structure required by optical elements, such as wave plates, diffractive optics, and polarization optics, which are used, especially, in the ultraviolet wavelength region, in the fields of optics and also required by antireflection means, which is typified by a moth-eye structure, is processed by using an inorganic material having good heat-resistance and weather-resistance, necessity for a costly apparatus used to perform etching or lithography techniques is eliminated. Also, a manufacturing process of the optical element can be simplified. As compared with the case of the element manufactured by processing a single material, it is unnecessary in the case of the optical element according to the invention to add a step of providing an anti reflection means to a manufacturing process.

### BRIEF DESCRIPTION OF THE DRAWINGS

FIGS. 1A to 1C are diagrams illustrating a process of manufacturing a transmission type optical element according to the invention.

FIG. 2 is a graph illustrating the difference in a spectral transmission characteristic due to the presence/absence of a coat on a substrate.

### DETAILED DESCRIPTION OF THE PREFERRED EMBODIMENTS

Hereinafter, a method of manufacturing a transmission type optical element having a convex/concave surface structure is described with reference to an embodiment based on a diffraction grating.

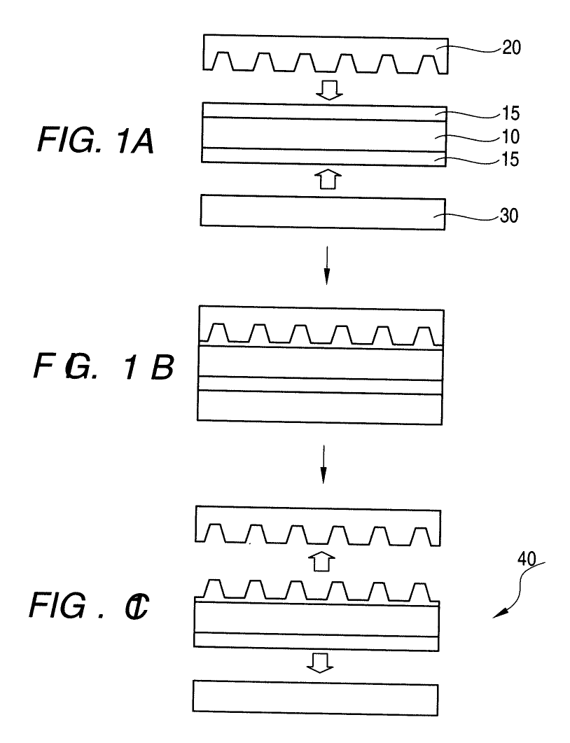

FIGS. 1A to 1C illustrate a basic process of manufacturing a diffraction grating according to the invention. Sol-like silicon alkoxide is applied on both surfaces of a substrate 10 to thereby form a coating film 15. The application of sol-like silicon alkoxide may be performed on each of the surfaces of the substrate 10 by spin-coating. However, in a case where the same kind of a binder solution is applied to both the surfaces of the substrate 10, it is simpler to simultaneously apply sol-like silicon alkoxide onto both the surfaces of the substrate. Subsequently, a preliminarily prepared forming die 20 having a diffraction grating shape is pressed against a film formed on one side of the substrate 10. Also, a plate-like substrate 30 is pressed against the other side of the substrate 10 (see FIG. 1A). Then, the substrates are heated by maintaining a state shown in FIG. 1B. Thus, the films are hardened. Then, as shown in FIG. 1C, demolding is performed. Consequently, a substrate 40 having a convex/concave structure can be formed.

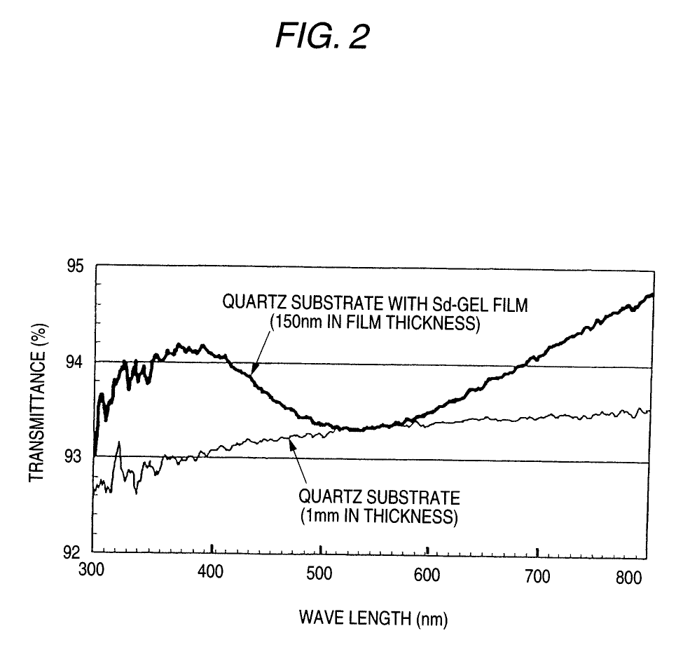

To evaluate the fundamental optical characteristic of the substrate, a binder solution obtained by adding polyethylene glycol to tetra-ethoxy-silane, which is a typical example of sol-like silicon alkoxide, and an acid aqueous solution was applied onto a 1 mm-thickness quartz glass substrate by spin-coating. Then, calcinations were performed thereon. Thus, a film including SiO2 as a main ingredient was formed. At that time, a film thickness was set at 150 nm by controlling the number of rotations of a spinner. This film thickness corresponded to (⅓) to (¼) of the wavelength in a case where light having a wavelength ranging from 200 nm to 600 nm. FIG. 2 shows a result of evaluation of the spectral transmittance of each of the film-coated substrate and an uncoated quartz glass substrate. The transmittance of the film-coated substrate at the wavelength of 360 nm, which is indicated by a thick solid curve, is about 94%. The transmittance of an uncoated quartz glass substrate, which is indicated by a thin solid curve, is about 93%. Thus, it is confirmed that the film-coated substrate was higher in transmittance than the uncoated quartz glass substrate.

Incidentally, the wavelength of 360 nm, at which the transmittance was determined, has no particular meaning and is employed as a representative wavelength in a near-ultraviolet region. As shown in FIG. 2, the transmission characteristic in this wavelength region of a material according to the invention has no absorption peak and gradually changes. Thus, even in a case where the representative wavelength is set at a value, which differs from 360nm, in a peripheral wavelength region, similar advantages can be obtained.

Hereinafter, examples are more specifically described.

### FIRST EXAMPLE

The forming die was configured so that periodical grooves were formed at a rate of 2400 lines/mm, and that the cross-section perpendicular to the longitudinal direction of each of the grooves was shaped like a sinusoidal wave. This forming die was used by being subjected to mold release processing. A binder solution obtained by adding polyethylene glycol to tetra-ethoxy-silane, an acid aqueous solution, and a sol solution containing ethanol as a main ingredient was applied onto both of the surfaces of the quartz glass substrate by dip-coating. The above forming die was pressed against one of the surfaces of the glass substrate, while the plate-like substrate was pressed against the other surface of the glass substrate. Incidentally, similarly to the forming die, the mold release processing was preliminarily performed on the surface of the plate-like substrate. In this state, the substrates were maintained at a temperature of 100° C. to thereby progress gelatinization and harden films. Then, the forming die and the plate-like substrate were released from the hardened film. Subsequently, the hardened gel film was baked. Consequently, a substrate, in which a convex/concave structure constituted by the periodical grooves was formed, was obtained.

The refractive index n of each of the obtained layer (or convex/concave film), in which the convex/concave structure was formed, and the flat film was 1.44 at the wavelength of 360 nm. Regarding a film thickness, the average thickness d1 of the convex/concave film was 290 nm, while the average thickness d2 of the convex/concave film was 270 nm. It is considered that because of the difference in flow ability of the binder solution due to the difference in surface area between the convex/concave film and the flat film, the flat film was thinner. That is, in a case where the convex/concave forming die was pressed against the substrate on which the binder solution was applied, the surface area of the substrate, with which the binder solution was brought into contact, was larger than the surface area, with which the binder solution was brought into contact, in a case where the flat substrate was pressed against the substrate on which the binder solution was applied. Thus, it is considered that the flowability of the binder solution in the former case was lower than the flowability thereof in the latter case. As the lower the flowability, the smaller an amount of the binder solution pushed out of the die when the die was pressed against the substrate. Consequently, the thickness of the film was increased.

According to the values of the refractive index and the film thicknesses, the optical film thickness n·d1 of the convex/concave film and that n·d2 of the flat film were obtained as 417.6 nm and 388.8 nm, respectively. In the case of the convex/concave film, at the wavelength λ=360 nm, the optical film thickness was as follows. That is, n·d1=5λ/4−32.4 (nm). Thus, a deviation from the odd-multiple (5 times in this case) of (λ/4) was (−7.2) %. Also, in the case of the flat film, at the same wavelength, the optical film thickness was as follows. That is, n·d2=5λ/4−61.2 (nm). Thus, a deviation from the odd-multiple (5 times in this case) of (λ/4) was (−13.6) %. Additionally, the obtained convex/concave depth was 0.25 μm.

When parallel light beams having a wavelength of 360 nm were incident upon the obtained substrate, diffracted light was generated. Thus, it was confirmed that the grating could serve as a transmission type diffraction grating, which was a transmission type optical element, in the ultraviolet wavelength region.

### SECOND EXAMPLE

First, tetra-methoxy-silane, an acid aqueous solution, and a sol solution containing methyl alcohol as a main ingredient were applied onto the rear surface of a sapphire substrate by spin-coating. Then, the coated substrate was treated with heat at 100° C. Consequently, a sol-gel film could be formed so that the refractive index n2 at the wavelength of 360 nm was 1.43, and that the film thickness d2 was 210 nm.

Subsequently, a convex/concave structure was formed on a surface of the substrate. A flat substrate, in the surface of which a large number of triangular-pyramid-like holes were provided, was used as the forming die. Tetra-ethoxy-silane, methyl-triethoxy-silane, an acid aqueous solution, and a sol solution containing ethanol as a main ingredient were applied onto the sapphire substrate. The sapphire substrate having been brought into a state, in which the forming die was pressed there against, was held at 60° C. to thereby harden a gel film. Subsequently, the die was released from the hardened gel film. Then, the film was baked. Consequently, the convex/concave structure was formed from the sol-gel film so that the refractive index n1 at a wavelength of 360 nm was 1.42, and that the average thickness d1 of the film thickness was 720 nm.

The optical film thickness n2·d2 of the rear-surface-side flat film was 300.3 nm, while the optical film thickness n1·d1 of the convex/concave film was 1022.4 nm. In the case of the flat film, at the wave length λ=360 nm, the optical film thickness n2·d2 was as follows. That is, n2·d2=3λ/4+30.3 (nm). Thus, a deviation from the odd-multiple (3 times in this case) of (λ/4) was 11.2%. Also, in the case of the convex/concave film, at the same wavelength, the optical film thickness was as follows. That is, n1·d2=13λ/4−147.6 (nm). Thus, a deviation from the odd-multiple (13 times in this case) of (λ/4) was (−12.6) %. Additionally, the obtained convex/concave depth was 0.2 μm.

The transmittance of the obtained substrate was evaluated. Thus, it was observed that the transmittance was increased by 2%, as compared with the case where no convex/concave structure was formed thereon. Also, it was confirmed that a transmission type optical element having an antireflection function due to what is called a moth-eye structure could be realized.

In the foregoing description of the embodiment, the diffraction grating and the antireflection means having what is called the moth-eye structure have been described. However, in addition to these elements, the invention can be applied to the transmission type optical elements, such as the wave plates and other polarization optics used in the ultraviolet wavelength region.

What is claimed is:

1. A transmission type optical element comprising:
a substrate; and
a layer having a convex/concave structure formed on one of surfaces of said substrate;
wherein a transmittance of each of said substrate and said layer having said convex/concave structure at a wavelength of 360 nm is set to be 90% or more, and
a refractive index of said layer having said convex/concave structure is less than a refractive index of said substrate.

2. A transmission type optical element according to claim 1, wherein a second layer which has a transmittance of 90% or more at a wavelength of 360 nm and which has a refractive index less than the refractive index of said substrate at the wavelength of 360 nm, is provided on another surface of said substrate, which is opposed to said one surface provided with said layer having said convex/concave structure.

3. A transmission type optical element according to claim 1, wherein said layer having said convex/concave structure is a layer on which said convex/concave structure is formed by molding and hardening a sol-like silicon alkoxide layer.

4. A transmission type optical element according to claim 1, wherein a material of said substrate is quartz glass or sapphire glass.

5. A transmission type optical element according to claim 2, wherein average thicknesses d1 and d2 of said layers that are respectively formed on both of said surfaces of said substrate and that have refractive indexes n1 and n2 at a wavelength λ, at which said transmission type optical element is utilized, are set so that each of values of optical thicknesses n1·d1 and n2·d2 of said layers is within a range defined by an odd multiple of (λ/4)±20%.

6. The transmission type optical element according to claim 1, wherein a depth of said convex/concave structure ranges from 0.1 μm to 0.9 μm.
